(19) United States
(12) Patent Application Publication
(10) Pub. No.: US 2010/0207071 A1
(43) Pub. Date: Aug. 19, 2010

(54) METHOD OF SELECTIVELY CONTROLLING SURFACE PROPERTIES OF THERMOPLASTIC POLYMER ARTICLES

(75) Inventors: Bhaskar Patham, Bangalore (IN); Soumendra K. Basu, Bangalore (IN)

Correspondence Address: Julia Church Dierker;Dierker & Associates, P.C., 3331 W. Big Beaver Road, Suite 109, Troy, MI, 48084-2813, US

(73) Assignee: GM GLOBAL TECHNOLOGY OPERATONS, INC., Detroit, MI (US)

(21) Appl. No.: 12/371,404

(22) Filed: Feb. 13, 2009

(51) Int. Cl. C08L 23/02; B05D 3/00; H01B 1/12

(52) U.S. Cl. 252/500; 427/398.1; 525/177; 524/513; 524/514; 525/184

(57) ABSTRACT

The present disclosure relates to thermoplastic polymer articles, and methods of making and/or selectively controlling surface properties of the same. The article includes a bulk thermoplastic polymer, and a cap layer formed in-situ thereon. A resin formulation used to form the articles includes the bulk polymer in an amount ranging from about 80 wt. % to about 99.5 wt. %, and a polymer additive (which forms the cap layer) in an amount ranging from about 0.5 wt. % to about 20 wt. %. The bulk polymer viscosity ranges from about 5 to about 1000 times higher than the polymer additive viscosity, and the polymer additive is immiscible in the bulk polymer. A predetermined surface property of the polymer additive, which is not inherent in the bulk polymer, is imparted to the cap layer, and thus to the article.

### TECHNICAL FIELD

The present disclosure relates generally to thermoplastic polymer articles, method of making the same, and methods of selectively controlling surface properties of the same.

### BACKGROUND

The goals of light-weighting, and achieving environmentally friendly manufacturing processes for automotive and aerospace components, are well served by greater utilization of thermoplastic components. However, in order to effectively utilize thermoplastic materials in diverse applications, it is often desirable to impart special functionalities to the materials forming such components. The need for many of these special functionalities, i.e., properties that are not inherent in the thermoplastic of choice, can often be addressed by modification of the surface of the polymeric component. The conventional methods employed for modifying the surfaces properties of polymeric components include coating, co-extrusion, surface cross-linking via high-energy radiation or ion bombardment, lamination, and masking. All of the previously mentioned techniques involve additional processing steps during the manufacturing of the component. Additional processing may, in some instances, increase the complexity and costs associated with manufacturing and/or increase the risk of defect formation.

### SUMMARY

Thermoplastic polymer articles with selectively controlled surface properties, and methods of making the same by employing novel thermoplastic resin formulations are disclosed herein. An example of the thermoplastic polymer article includes a bulk thermoplastic polymer having a predetermined viscosity, and a surface cap layer composed of a polymer additive having a predetermined surface property that is not inherent in the bulk polymer. The surface cap layer is formed in-situ on the bulk thermoplastic polymer core during processing of the article. The resin formulation includes the bulk polymer in an amount ranging form about 80 wt. % to about 99.5 wt. %, and the polymer additive in an amount ranging from about 0.5 wt. % to about 20 wt. %. The predetermined viscosity of the bulk polymer ranges from about 5 to about 1000 times higher than a viscosity of the polymer additive, and the polymer additive is immiscible in the bulk polymer. The predetermined surface property of the polymer additive is imparted to the cap layer, and thus to the thermoplastic polymer article.

### BRIEF DESCRIPTION OF THE DRAWING

Features and advantages of examples of the present disclosure will become apparent by reference to the following detailed description and drawing, in which like reference numerals correspond to similar, though not necessarily identical, components.

FIG. 1 is a schematic flow diagram depicting an example of the method of forming the thermoplastic polymer article, in which: the first view shows one embodiment of a resin formulation including a bulk thermoplastic polymer (i.e., bulk of article) and a polymer additive (i.e., cap layer imparting desirable surface properties to article), before processing; the second view shows an embodiment of the flow-induced rearrangement of the resin formulation during high shear-rate flow processing; and the third view shows the resulting thermoplastic polymer article after cooling.

### DETAILED DESCRIPTION

It has been observed that when two fluids with different viscosities are made to flow together through a mold, the fluid configurations are rearranged such that the low viscosity fluid occupies regions of high shear rates, while the high viscosity fluid occupies regions of low shear rates (i.e., a core-skin flow configuration). Generally, the greater the viscosity ratio, the faster is the rearrangement and segregation of the fluids. At very high viscosity ratios, the low-viscosity fluid forms a uniform, thin, slip layer adjacent to the mold surfaces, and the high-viscosity fluid forms a core away from the mold surfaces. Such segregation may be further facilitated by the reduction of the surface tension of the low-viscosity fluid. For example, fluorinated polymers have been employed to form a slip layer that eliminates shark-skin flow instabilities in extrusion flows at high stresses. Core-skin type flow has also been observed during extrusion of oil-extended, vulcanized, rubber-reinforced thermoplastics, where the oil segregates from the bulk and forms a slip layer that coats the extruded bulk.

The principle of viscosity and surface tension-driven layer segregation has been successfully employed in creating layered structures in conventional coating and powder coating processes. However, this principle has not been employed to create parts/articles with layered structures formed in situ during conventional processing of thermoplastics, as proposed in the present disclosure. This principle has also not been contemplated for or used to deliver specific functionality to a surface of an article that is drastically different from that of the bulk of the article (beneath the surface) through careful choice of a low viscosity polymeric additive, as shown in the present disclosure. Such delivery of specific functionality and the marked difference between the surface and the bulk materials can be achieved via the embodiments described in detail below.

Embodiments of the method disclosed herein advantageously expand on the phenomenon of flow induced layer segregation to form a thermoplastic polymer component or article having one or more predetermined or pre-selected surface properties. The methods result in the formation of a layer having desirable surface properties for the article, which may be different than and not inherent in the bulk polymer. Since the layer having the desirable surface properties is formed in situ (i.e., during the processing of the article), additional surface modifying processes are unnecessary. As such, the method(s) disclosed herein may be single-step processes which eliminate the need for additional surface modification.

Some of the surface properties, that may be particularly desirable for thermoplastic articles, and that can be incorporated by the methods described in the present disclosure, include chemical resistance, class-A surface finish, surface conductivity, flame retardance, and wear resistance. Non-limiting examples of limitations of thermoplastics that can be overcome by the selective surface modification techniques disclosed include, but are not limited to the following: i) the poor chemical resistance of amorphous engineering thermoplastics, that otherwise limit their applicability in the vicinity of fuel and fuel lines, despite their high stiffness and superior high temperature properties; ii) surface defects driven by process instabilities and differential shrinkage in injection molded polymer blends and filled polymers that interfere with their incorporation in applications requiring a class-A surface finish (as used herein, the phrase “class-A surface finish” refers to a degree of smoothness of a part's surface which is of particularly high gloss and reflectivity); iii) extremely poor electrical conductivity of polymers, which may otherwise require bulk additive modifications to enable electro-deposition of powder coatings on them; iv) poor wear resistance of some of transparent amorphous thermoplastics that limits their employment in glazing applications; and v) flammability of polymers which limits their use in multiple metal-replacement applications. Using the embodiments of the method disclosed herein, one or more of these undesirable properties may be overcome. The method(s) disclosed herein are unlike conventional methods, which often include one or more remedial steps.

As previously mentioned, the methods disclosed herein can eliminate additional remedial steps, such as, coating, lamination, co-extrusion, etc. used for modifying the surface properties of thermoplastic parts. As such, the methods disclosed herein advantageously reduce the overall processing time, and potentially the processing costs. Instead of imparting the surface property by employing an additional coating/co-extrusion/lamination step, the present disclosure uses particular formulations, wherein specially selected and/or configured low viscosity polymer additives are added to a bulk thermoplastic, with the low viscosity polymer additives forming a separate phase. High shear rates used during injection molding or extrusion cause the two-phase formulation to separate in-situ into a core-skin flow configuration that ultimately results in a cap layer with the desired property on the surface of the part. Furthermore, the desired surface properties are imparted without any modification of the existing manufacturing process.

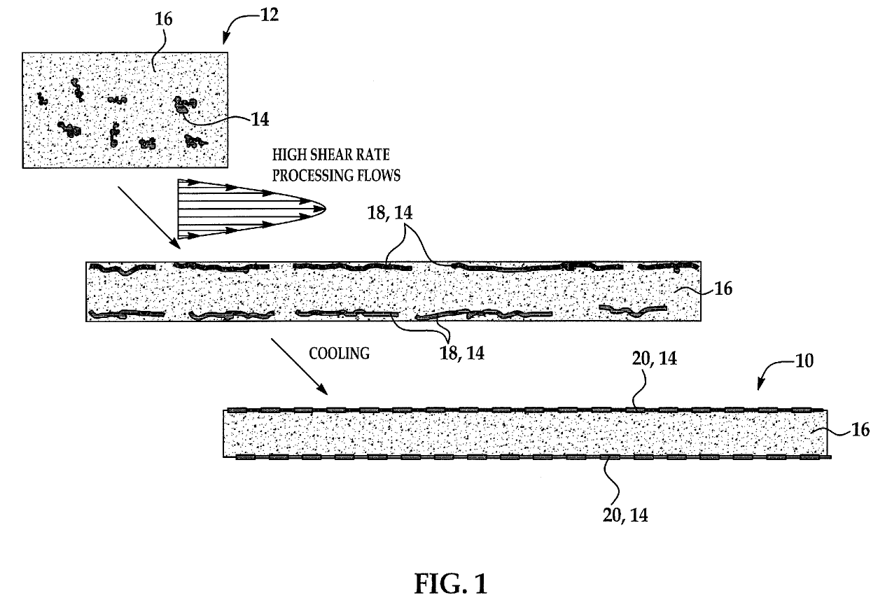

Referring now to FIG. 1, a schematic flow diagram illustrating an example of the method of making the article 10 is shown. In the first view, the resin formulation 12 of the thermoplastic polymer additive 14 and the bulk thermoplastic polymer 16 is depicted. It is to be understood that this schematic illustration is the formulation 12 before being subjected to processing. Between the first and second views, the formulation 12 is exposed to processing involving a predetermined high shear rate. As such, the second view illustrates the formation of a slip layer 18 from the thermoplastic polymer additive 14. Generally, the shear rate causes the thermoplastic polymer additive 14 to substantially uniformly migrate to the surface of the thermoplastic bulk material 16. The slip layer 18 is then cooled, thereby solidifying the thermoplastic polymer additive slip layer 14, 18 into a cap layer 20 on the bulk thermoplastic polymer 16. The method disclosed herein therefore involves both a processing aspect and a formulation aspect.

As depicted in FIG. 1, the processing aspect of this method involves achievement of the in-situ generation of core-skin flow configuration during processing. More particularly, the property-specific low viscosity polymer additives 14 form a separate phase within the bulk thermoplastic polymer 16 during processing. When the formulation 12 is subjected to a high shear rate ranging from about 100 s⁻¹ to about 10,000 s⁻¹, and a processing temperature ranging anywhere from about 100° C. (for polyolefinic copolymers and elastomers) to about 400° C. (for high temperature structural bulk polymers such as poly(ether imids)), the low viscosity additive 14 migrates to the surface of the bulk thermoplastic 16 and creates a uniform slip layer 18, which, after cooling forms the uniform cap layer 20 on the part 10. It is to be understood that the temperatures required for optimum melting and flow of the polymer formulations, and the shear rates required for in-situ segregation of the components, are typical of extrusion and injection-molding processes that are employed for the manufacture of the part. Thus, the surface modification of the part 10 in the examples disclosed herein takes place during the formation of the part 10.

The formulation aspect of the methods disclosed herein involves the choice of the bulk polymer 16 and the additive 14 in order to achieve the desirable surface properties, and the determination of the optimal proportions of the bulk polymer 16 and the additive 14 in the formulations. The additive polymer 14 may also contain carefully selected property modifying agents (of relevance to the ultimate surface property of the part), which are exclusively retained in the polymer additive phase 14. The viscosity (and therefore, molecular weight) of the polymer additive 14 (including any surface property specific modifiers, where applicable) is selected such that the viscosity ratio (i.e., the ratio of the viscosity of the additive 14 to that of the bulk 16) is low enough to ensure rapid establishment of core-skin flow configuration. At the same time, the molecular weight of the polymer additive 14 is selected to be high enough to impart the desired surface properties (such as, for example, chemical resistance and scratch resistance, which are strongly dependent on the molecular weight of the polymer additive up to an optimal threshold).

Further detailing the formulation aspects of the method disclosed herein, as shown in FIG. 1, the resin formulation 12 includes the bulk polymer 16 (which will constitute the majority of the resulting article 10, and will impart the bulk properties, such as stiffness and heat deflection temperature, to the part), and small amounts of the thermoplastic polymer additive 14 (which will form the skin or cap layer on the part, and which will impart the desired surface properties, such as chemical resistance, that are not inherent in the bulk polymer). It is to be understood that the surface property imparted to the part 10, by the chosen additive 14, is either the result of the structure/chemistry of the additive 14, or is due to the addition of property modifiers, such as micro- or nano-scale fillers (including, but not limited to, fillers such as nano-silicates, carbon black, etc.), and surface tension modifiers, such as fluoro-polymers or silicones that are exclusively retained in the additive 14 during processing.

The bulk polymer 16 is a thermoplastic possessing properties that satisfy the bulk requirements, such as stiffness, of the article and may be an unfilled polymer, a filled polymer, or a polymer blend. Examples of unfilled polymers include, but are not limited to, (a) crystallizable thermoplastics such as polyolefins (e.g., linear and branched polyethylenes (PE), polypropylenes (PP), or poly(vinyl chlorides) (PVC), polyesters (e.g., poly(ethylene terephthalate) (PET), poly(butylene terephthalate) (PBT), poly(ethylene naphthalate) (PEN)), or polyamides (PA) (e.g., nylon-6, nylon-66, nylon-46), (b) amorphous engineering thermoplastics, such as acrylates (e.g., poly(methyl methacrylate) (PMMA)), polycarbonates (PC), or poly(ether imids) (PEI), (c) random and/or block copolymers, such as polyolefinic random copolymers (e.g., ethylene-propylene (EP) copolymers, ethyelene-butylene (EB) copolymers, or ethylene-octene (EO) copolymers), styrenic block copolymers (e.g., acrylonitrile-butadiene-styrene (ABS), or styrene-acrylonitrile (SAN)), and (d) elastomers, such as poly(butylene) (PB), poly(iso-butylene) (PIB), poly(phenylene sulfide) (PPS), poly(phenylene oxide) (PPO), poly(phenylene ether) (PPO), and siloxane based elastomers (e.g., poly(dimethyl siloxane) (PDMS)). Polymer blends are systems that are typically comprised of one polymer (including, but not limited to one of the above listed polymers) as the matrix, and one or more polymers (including, but not limited to one or more of the above listed polymers) as the dispersed phase. Some non-limiting representative examples of miscible (single-phase) polymer blends include PPO/PS, PPE/PS, and immiscible (two- or more phase) polymer blends include thermoplastic olefin (TPO) blends (e.g., EP/PP, EB/PP, EO/PP), thermoplastic vulcanizates (e.g., oil-extended vulcanized rubber/PP), ABS/PC, SAN/PS, Nylon/PP, PBT/PC, PBT/PEI, PPO/PA, etc. Filled polymers are systems that are typically comprised of isotropic or anisotropic micro- or nano-fillers (including but not limited to, carbon black, carbon fibers, single walled carbon nanotubes (SWNT), multi-walled carbon nanotubes, micro-talk, nano-talc, metallic nanoparticles, metallic micro- or nano-fibers and whiskers, glass micro-spheres, micro-talc, nano-talc, glass fibers, layered silicates, mica, nano-clay, polymeric micro- or nano-fibers, etc.) incorporated into the bulk of the polymer (including, but not limited to one of the above listed unfilled polymers), or into either or both phases of a polymer blend (including but not limited to the representative examples cited above).

Transparent amorphous thermoplastics, such as, polycarbonates, acrylates or polystyrenes (e.g., which are suitable for use in glazings for glass replacement), thermoplastics such as polyamides, polycarbonates, and poly(ether imids) (which are often desirable, because of their high temperature properties, for automotive applications), polyolefins, polyolefin copolymer elastomers, and blends of polyolefins and thermoplastic elastomers (e.g., which are suitable for use as instrument panels, fenders, etc.), filled polymers, and other engineering thermoplastics (such as PC and PEI, which are suitable for use in semi-structural applications) are some non-limiting examples of the bulk polymeric systems 16, which, while satisfying the bulk requirements, do not always satisfy desirable surface property requirements (such as chemical resistance, scratch resistance, surface electrical conductivity, etc.). It is to be understood that the above listed polymers serve as possible examples, and is not an exhaustive list.

As mentioned above, in many typical applications, the desirable structural and the surface property requirements of the article can be drastically different, and the bulk polymer 16 may not be able to satisfy the surface property requirement. In the embodiments disclosed herein, this property is then imparted by the appropriate selection of the thermoplastic polymer additive 14. As such, the thermoplastic polymer additive 14 is the polymer that will be employed to provide the desired surface property to the article 10. Examples of such polymer additives 14 may include neat (unfilled) polymers, neat (unfilled) random or block-copolymers, or highly functionalized polymers containing one or more chemical modifiers and/or nano-scale fillers. Generally, the thermoplastic polymer additive 14 has a lower viscosity than the viscosity of the bulk polymer 16, and is immiscible in the bulk polymer 16. In particular, the viscosity of the bulk polymer 16 is 5 to 1000 times higher than the viscosity of the thermoplastic polymer additive 14, and more desirably, the viscosity of the bulk polymer additive 16 is 10 to 100 times higher than the viscosity of the thermoplastic polymer additive 14, under the processing shear rates and temperatures employed.

As non-limiting examples, the thermoplastic polymer additive 14 may be (a) a low viscosity, neat, semi-crystalline, chemical resistant polymer (e.g., PE, PP, or PBT to improve the chemical resistance of the part surface), or (b) a chemically modified semi-crystalline or amorphous polymer (e.g., fluoro-polymer capped polyolefins, that have low surface energy, to facilitate easier migration to surface, and to impart a masking effect on injection molded articles to improve optical properties), or (c) a chemically modified semi-crystalline or amorphous polymer containing nano-scale fillers for providing special functionality to the surface (e.g. nano-clay for improving scratch and wear resistance), or (d) chemically modified polymer containing conductive nano-scale fillers (e.g., metallic nano-whiskers, nano-scale carbon black particles, carbon nanotubes, carbon fibers, etc. to improve the surface conductivity).

In addition to the above description, the polymer additive 14 selected also has a high enough melting point so that it does not degrade while being exposed to the processing temperatures (from approximately 100° C. to 400° C.) and shear rates (from approximately 100 s⁻¹ to 10000 s⁻¹), is sufficiently heat stabilized, is preferably linear to facilitate ready crystallization (where applicable), and is not fully compatible with the bulk polymer 16. It is to be understood that the compatibility is low enough to ensure establishment of the skin layer 18, while being high enough to ensure good contact between the solidified cap layer 20 and the bulk polymer 16).

Once the choice of the polymer additive 14 is made, the percentage of the polymer additive 14 to be used along with the bulk polymer 16 in the formulation 12 is determined. It is to be understood that the polymer additive content is to be high enough to ensure the formation of a sufficient thickness of the cap layer, but should not be so high as to deleteriously affect the bulk properties desired of the article. The polymer additive 14 content (including, in some instances, chemical modifiers and nano-scale fillers) may be on the order of about 0.5 to about 20 weight % of the total resin formulation, and more desirably in the range about 0.5 to about 5 weight % of the total resin formulation. As such, the total resin formulation 12 includes from about 80 weight % to about 99.5 weight % of the bulk polymer 16.

Generation of the formulation 12, including the thermoplastic bulk polymer 16 and the low viscosity polymer additive 14, may be carried out in a twin screw extruder followed by pelletization, prior to the processing operation to make the article 10. Alternatively, the twin-screw extruder employed to combine the two polymers 14, 16 can immediately feed the formulation 12 to the processing operation for part production, thereby eliminating a second heat cycle.

During processing of the formulation 12 to generate the part, the shear rates have to be high enough to ensure rapid formation of a core-skin flow configuration, while at the same time not being too high in order to avoid unstable transitions. In an embodiment, the low-viscosity polymer additive 14 forms a substantially uniform skin layer 18 around the bulk polymer core 16. The skin layer 18, in contact with an external mold wall (not shown), cools down, forming the cap layer 20 (which, in some instances is crystallized) that imparts the desired surface functionality to the bulk polymer 16 (and the article 10).

The methods disclosed herein may be used to overcome one or more surface property limitations of certain thermoplastic polymeric components (which have other desirable bulk properties), thereby expanding the environments and/or applications in which the components may be used.

As an example, glassy thermoplastic polymers such as poly(carbonate)s, poly(etherimid)s, and acrylates have high stiffness compared to commodity polymers such as poly(propylene) and poly(ethylene). By virtue of their high glass transition temperature, glassy thermoplastic polymers can also be employed for high temperature applications. As such, glassy thermoplastic polymers may be employed as engineering bulk materials for structural applications. Furthermore, due to their transparency (in the case of acrylates, polycarbonates and polystyrenes), they have potential for replacing glass in glazing applications. However, due, at least in part, to their amorphous and polar nature (in some instances), such materials have poor chemical resistance. The methods disclosed herein provide process-aided in-situ establishment of the core-skin flow configuration mechanism to transport a chemically resistant polymeric additive to the surface of the engineering bulk thermoplastic part during processing. More particularly, the chemical resistance of the surfaces of parts manufactured by processing operations involving high shear-rate deformations of engineering bulk thermoplastic polymers or blends thereof (i.e., the bulk polymer 16) is improved by employing formulations which, in addition to the engineering bulk thermoplastic polymers or blends thereof, contain a small amount of chemically resistant, crystallizable polymers or nano-composites thereof (i.e., the additive 14) having molecular weights and viscosities lower than that of the engineering bulk polymer (or the average viscosities of the blends, where applicable). Such low viscosity additives 14 form a uniform and effective thin skin layer by virtue of the shear field imposed in the processing operation and crystallize on the surface of the bulk polymer 16 upon cooling.

As another example, many plastic components do not exhibit the desirable Class-A surface finish, especially parts manufactured with polymer blends or polymer matrix composites. In a thermoplastic olefin (TPO)-based injection molded part, a commonly encountered visual defect is flow lines or tiger-striping. These are due, at least in part, to instabilities of the flow front during mold filling. In injection molding of glass filled polymers, the glass fibers tend to crowd at the surface, giving rise to a rough surface appearance. In injection molding of polymers with high filler content, a common problem is that weld lines form in areas where flow fronts rejoin after separation around an obstacle. All of these defects make the final plastic component non Class-A, thereby rendering such parts unsuitable for use in regions of direct view. The methods disclosed herein provide process-aided in-situ establishment of the core-skin flow configuration mechanism to transport a low viscosity polymer to the surface of the plastic part during injection molding so as to provide a filler free layer for masking any filler-related optical surface defects. More particularly, the surface finish of parts manufactured by injection molding operations involving high shear-rate deformations of filled polymers and/or polymer blends (i.e., the bulk polymer 16) is improved by employing formulations which contain, in addition to the bulk polymer 16, a small amount of unfilled polymers (i.e., the additive 14) having molecular weights and viscosities lower than that of the filled polymer (or the average viscosities of the blends, where applicable). Such unfilled polymer additives 14 form a uniform and effective thin skin layer by virtue of the shear field imposed in the molding operation and solidify on the surface of the bulk polymer 16 upon cooling, thereby providing a masking cap layer 20 to hide any optical defects due to the filler or blend morphology of the bulk polymer 16.

As still another example, it may be desirable to modify the surfaces of polymers that are intended to replace metals. For instance, it may be desirable to increase the electrical conductivity (for paint and powder coating electro-deposition applications) and wear resistance (for Class-A surfaces as well as glazing applications) and/or flame retardance. The methods disclosed herein provide process-aided in-situ establishment of the core-skin flow configuration mechanism to transport the functional additives (incorporated in a low viscosity polymer) to the surface of the plastic part during the processing operation so as to provide a selective surface functionality to the plastic component instead of bulk addition of the functionality or by surface modification step, such as, coating. More particularly, the functionality (e.g., conductivity, wear resistance and/or flame retardance) of parts manufactured by processing operations involving high shear-rate deformations of polymers (i.e., bulk polymer 16) is selectively imparted to the polymeric component surface by employing formulations which contain a small amount of highly functionalized polymers (i.e., the additive 14) of molecular weights and viscosities lower than that of the bulk polymer. Such additives 14 form a uniform and effective thin skin layer by virtue of the shear field imposed in the molding operation and solidify on the surface of the bulk polymer 16 upon cooling, thereby providing a functionalized cap surface.

To further illustrate embodiment(s) of the present disclosure, examples are given herein. It is to be understood that these examples are provided for illustrative purposes and are not to be construed as limiting the scope of the disclosed embodiment(s).

### PROPHETIC EXAMPLES

### Example 1

In order to make a fuel line with an amorphous engineering thermoplastic, such as glass-fiber filled amorphous nylon, or polycarbonate which has the high temperature properties desired for fuel-line applications, a low-viscosity, chemically-resistant, crystallizable olefinic polymer (such as polypropylene or fluoro-polymer capped PP, to further reduce the surface tension of the PP) may be added to the bulk. The olefinic polymer can provide the resistance to chemical degradation that is often lacking in the amorphous engineering thermoplastic. The molding may be performed at high shear rates on the order of 1000 s⁻¹, so as to allow the olefinic polymer to migrate to the surface of the amorphous engineering thermoplastic and crystallize, thereby overcoming the chemical limitations of the amorphous bulk polymer.

### Example 2

Instead of the unfilled olefinic polymer in the above example, a master-batch of a highly functionalized crystallizable polymer with nano-fillers may be used. For example, the crystallizable polymer may be a maleated PP including nano-clay having sufficient polymeric modifications to ensure its retention within the PP. In this example, the cap layer may exhibit the property of wear resistance, in addition to being crystalline.

### Example 3

To make a conductive part to enable electro-deposition of a powder coating thereon, the polymer additive may be in the form of a master-batch of the low viscosity polymer, with a high loading of nano-conductive fillers (such as carbon black or metallic nano-whiskers). During processing, these additive fillers migrate to the surface along with the skin layer, thereby forming a conductive cap layer.

While several embodiments have been described in detail, it will be apparent to those skilled in the art that the disclosed embodiments may be modified. Therefore, the foregoing description is to be considered exemplary rather than limiting.

1. A method for selectively controlling surface properties of a thermoplastic polymer article, the method comprising:
selecting a bulk thermoplastic polymer and a thermoplastic polymer additive such that i) the bulk polymer has a viscosity that is from about 5 to about 1000 times higher than a viscosity of the polymer additive, ii) the thermoplastic polymer additive has a predetermined surface property that is not inherent in the bulk thermoplastic polymer, and iii) the thermoplastic polymer additive is immiscible in the bulk thermoplastic polymer;
adding a predetermined amount of the thermoplastic polymer additive to a predetermined amount of the bulk thermoplastic polymer, thereby generating a resin formulation;
processing the resin formulation at a shear rate sufficient to achieve in situ separation of the thermoplastic polymer additive to a surface of the bulk thermoplastic polymer, thereby forming a slip layer on the bulk thermoplastic polymer; and
cooling the slip layer, thereby forming a cap layer on the surface of the bulk thermoplastic polymer, the cap layer imparting the predetermined surface property of the thermoplastic additive to the bulk thermoplastic polymer.

2. The method of claim 1 wherein the bulk thermoplastic polymer has a viscosity that is from 10 to 100 times higher than the viscosity of the thermoplastic polymer additive.

3. The method of claim 1 wherein the predetermined amount of the thermoplastic polymer additive in the resin formulation ranges from about 0.5 weight % to about 20 weight %, and wherein the predetermined amount of the bulk thermoplastic polymer in the resin formulation ranges from about 80 weight % to about 99.5 weight %.

4. The method of claim 1 wherein the predetermined surface property is selected from the group consisting of chemical resistance, Class-A surface finish, conductivity, flame retardance, wear resistance, and combinations thereof.

5. The method of claim 1 wherein the thermoplastic polymer additive includes at least one of an unfilled homopolymer, an unfilled random copolymer, an unfilled block-copolymer, or combinations thereof.

6. The method of claim 5 wherein the thermoplastic polymer additive is chemically functionalized and further includes nano-scale fillers that are selectively retained in the thermoplastic polymer additive slip and cap layers.

7. The method of claim 5 wherein the thermoplastic polymer additive is chemically modified with fluro-polymers or silicone polymers to reduce surface energy of the thermoplastic polymer additive.

8. The method of claim 1 wherein the thermoplastic polymer additive is selected from the group consisting of i) chemically-resistant, semi-crystalline, unfilled polymers of molecular weights lower than a molecular weight of the bulk thermoplastic polymer; ii) chemically modified crystallizable polymers containing nano-additives; iii) chemically modified amorphous polymers containing nano-additives; iv) chemically modified polymers containing conductive nano-additives; and combinations thereof.

9. The method of claim 8, wherein one of:
the chemically-resistant, semi-crystalline, unfilled polymers are selected from the group consisting of polyolefins, polyesters, and combinations thereof;
the chemically modified crystallizable polymers containing nano-additives are selected from the group consisting of polyolefins, polyesters, or combinations thereof, each of which contains at least one of: layered silicate nano-particles selected from mica, clay or combinations thereof, metallic nano-spheres or whiskers; carbon nano-particles; and combinations thereof;
the chemically modified amorphous polymers containing nano-additives are selected from the group consisting of polycarbonates, acrylates, poly(ether imids), elastomers, and random copolymers, each of which contains at least one of: layered silicate nano-particles selected from mica, clay or combinations thereof; metallic nano-spheres or whiskers; carbon nano-particles; and combinations thereof; or
the chemically modified polymers containing conductive nano-additives are selected from the group consisting of functionalized polyolefins, functionalizes polyesters, polycarbonates, acrylates, poly(ester imids), elastomers, and random copolymers, and wherein the conductive nano-additives are selected from the group consisting of metallic nano-spheres or whiskers, carbon nano-particles and combinations thereof.

10. The method of claim 1 wherein the processing step is conducted at a temperature ranging from about 100° C. to about 400° C. and at a shear rate ranging from about 100 s⁻¹ to about 10,000 s⁻¹.

11. The method of claim 1 wherein the processing step is selected from the group consisting of injection molding, extrusion, or combinations thereof.

12. The method of claim 1 wherein the bulk thermoplastic polymer is selected from the group consisting of an unfilled homopolymer, an unfilled random copolymer, an unfilled block-copolymer, a polymer blend, and combinations thereof.

13. The method of claim 1 wherein the bulk thermoplastic polymer is reinforced with fillers selected from the group consisting of isotropic microfillers, anisotropic microfillers, isotropic nanofillers, anisotropic microfillers and combinations thereof.

14. The method of claim 1 wherein the bulk thermoplastic polymer is selected from the group consisting of (a) crystallizable thermoplastics, (b) amorphous engineering thermoplastics, (c) random or block copolymers, (d) elastomers, (e) polymer blends, (f) filled polymers, (g) transparent amorphous thermoplastics, (h) thermoplastics with high temperature properties or other properties suitable for auto interiors or exteriors, and (i) engineering thermoplastics.

15. The method of claim 14 wherein one of:
the crystallizable thermoplastics are selected from the group consisting of polyolefins, polyesters, polyamides, and combinations thereof;
the amorphous engineering thermoplastics are selected from the group consisting of acrylates, polycarbonates, poly(ether imids), and combinations thereof;
the random or block copolymers are selected from the group consisting of polyolefinic random copolymers, styrenic block copolymers, and combinations thereof;
the elastomers are selected from the group consisting of poly(butylenes), poly(iso-butylene), poly(phenylene sulfide), poly(phenylene oxide), poly(phenylene ether), siloxane based elastomers, and combinations thereof;
the polymer blends are selected from the group consisting of miscible, single-phase polymer blends, immiscible, multi-phase polymer blends, thermoplastic vulcanizates, and combinations thereof;
the filled polymers are selected from the group consisting of polymers including at least one of isotropic microfillers, anisotropic microfillers, isotropic nano fillers, anisotropic nanofillers, or combinations thereof;
the transparent amorphous thermoplastics are selected from the group consisting of polycarbonates, acrylates, polystyrenes and combinations thereof;
the thermoplastics with high temperature and other properties suitable for auto interiors and exteriors are selected from the group consisting of polyamides, polycarbonates, poly(ether imids), polyolefins, polyolefin copolymer elastomers, blends of polyolefins and thermoplastic elastomers, and combinations thereof; or
the engineering thermoplastics are selected from the group consisting of filled polymers, glass-filled polyolefins, polyesters, polyamides, polycarbonates, poly(ether imids), and combinations thereof.

16. A thermoplastic polymer article, comprising:
a bulk thermoplastic polymer having a predetermined viscosity, the bulk thermoplastic polymer being present in a resin formulation used to form the article in an amount ranging from about 80 weight % to about 99.5 weight %;
a cap layer formed in-situ on the bulk thermoplastic polymer, the cap layer including a thermoplastic polymer additive being present in the resin formulation used to form the article in an amount ranging from about 0.5 weight % to about 20 weight %, the predetermined viscosity of the bulk thermoplastic polymer being about 5 to about 1000 times higher than a viscosity of the polymer additive, and the polymer additive being immiscible in the bulk thermoplastic polymer; and
a predetermined surface property of the thermoplastic polymer additive, which is not inherent in the bulk thermoplastic polymer, imparted to the cap layer and thus to the thermoplastic polymer article.

17. The thermoplastic polymer article of claim 16 wherein the predetermined surface property is selected from the group consisting of chemical resistance, Class-A surface finish, conductivity, flame retardance, wear resistance and combinations thereof.

18. The thermoplastic polymer article of claim 16 wherein the thermoplastic polymer additive includes at least one of an unfilled homopolymer, an unfilled random copolymer, an unfilled block-copolymer, or combinations thereof.

19. The thermoplastic polymer article of claim 16 wherein the bulk thermoplastic polymer is selected from the group consisting of an unfilled homopolymer, an unfilled random copolymer, an unfilled block copolymer, a polymer blend, and combinations thereof.
